(19) United States
(12) Patent Application Publication
(10) Pub. No.: US 2026/0245557 A1
(43) Pub. Date: Aug. 20, 2026

(54) SYSTEMS AND METHODS FOR DETERMINING DATA MISAPPROPRIATION USING ADVANCED COMPUTATIONAL MODELS FOR DATA ANALYSIS AND AUTOMATED PROCESSING

(71) Applicant: BANK OF AMERICA CORPORATION, Charlotte, NC (US)

(72) Inventors: Chelladurai R, Chennai, Tamilnadu (IN); Umme Kulsum Shaik, Hyderabad, Telangana (IN); Parthiban N, Tiruvannamalai, Tamil Nadu (IN); Gogulsundhar Palanivel, Salem, Tamil Nadu (IN); Archana R, Chennai, Tamilnadu (IN); Ruthra Prakash Radhakrishnan, Chennai, Tamilnadu (IN)

(73) Assignee: BANK OF AMERICA CORPORATION, Charlotte, NC (US)

(21) Appl. No.: 19/058,179

(22) Filed: Feb. 20, 2025

(51) Int. Cl. G10L 15/26; G06F 40/274; H04M 3/436

(52) U.S. Cl. CPC G10L 15/26; G06F 40/274; H04M 3/4365; H04M 2201/40

(57) ABSTRACT

Systems, computer program products, and methods are described herein for determining data misappropriation using advanced computational models for data analysis and automated processing. The present disclosure is configured to receive a communication message and transform the communication to a text message. The present disclosure is configured to predict the caller's communication message and classify the caller's predicted communication message. Further, the present disclosure is configured to extract key details from the text message and verify the key details with a database. Further still, the present disclosure is configured to generate a classification notification and a verification notification and transmit the notifications to a user device.

### TECHNOLOGICAL FIELD

Example embodiments of the present disclosure relate to systems and methods for determining data misappropriation using advanced computational models for data analysis and automated processing.

### BACKGROUND

There are significant issues associated with determining vishing attempts. Applicant has identified a number of deficiencies and problems associated with conventional solutions for determining vishing attempts. Through applied effort, ingenuity, and innovation, many of these identified problems have been solved by developing solutions that are included in embodiments of the present disclosure, many examples of which are described in detail herein.

### BRIEF SUMMARY

The following presents a simplified summary of one or more embodiments of the present disclosure, in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments of the present disclosure in a simplified form as a prelude to the more detailed description that is presented later.

Systems, methods, and computer program products are provided for determining data misappropriation using advanced computational models for data analysis and automated processing.

Embodiments of the present invention address the above needs and/or achieve other advantages by providing apparatuses (e.g., a system, computer program product, and/or other devices) and methods for determining data misappropriation using advanced computational models for data analysis and automated processing. The system embodiments may comprise a processing device and a non-transitory storage device containing instructions when executed by the processing device, to perform the steps disclosed herein. In computer program product embodiments of the invention, the computer program product comprises a non-transitory computer-readable medium comprising code causing an apparatus to perform the steps disclosed herein. Computer implemented method embodiments of the invention may comprise providing a computing system comprising a computer processing device and a non-transitory computer readable medium, where the computer readable medium comprises configured computer program instruction code, such that when said instruction code is operated by said computer processing device, said computer processing device performs certain operations to carry out the steps disclosed herein.

In some embodiments, the present disclosure provides a solution that may receive, via a user device associated with a user, a communication message comprising either an incoming communication message or an outgoing communication message, wherein the communication message is either transmitted to or received from a caller device, and wherein the communication message comprises real-time voice communication between the user and a caller. In some embodiments, the solution may transform, via an Automatic Speech Recognition (ASR) engine, the communication message to a text message. In some embodiments, the solution may predict, via a Large Language Model (LLM), the caller's communication message prior to the caller's communication message being delivered to the user. In some embodiments, the solution may classify, via a classification model, the caller's predicted communication message. In some embodiments, the solution may extract one or more key details from the text message, wherein the key details comprise the caller's name, the company associated with the caller, and the caller device's address. In some embodiments, the solution may verify the one or more key details via comparing the one or more key details with a database. In some embodiments, the solution may generate a classification notification comprising the classification of the caller's predicted communication message, wherein the classification notification configures a graphical user interface of the user device. In some embodiments, the solution may generate a verification notification comprising a verification status of the one or more key details, wherein the verification notification configures the graphical user interface of the user device. In some embodiments, the solution may transmit the classification notification and the verification notification to the user device.

In some embodiments, the caller device address may be unrecognized by or unknown to the user device.

In some embodiments, verifying the one or more key details may include querying the database using the one or more key details, retrieving a legitimate match from the database, and configuring the verification notification to indicate the legitimate match.

In some embodiments, verifying the one or more key details may include querying the database using the one or more key details, receiving a mismatch from the database, and configuring the verification notification to indicate the mismatch and to indicate the communication message is probable vishing.

In some embodiments, verifying the one or more key details may include transmitting a verification message to the company associated with the caller, wherein the verification message requests confirmation that the caller is associated with the company. In some embodiments, verifying the one or more key details may include configuring the verification notification to indicate the communication message is either authentic, upon receiving confirmation from the company that the caller is associated with the company; vishing, upon receiving information from the company that the caller is not associated with the company; or vishing, upon the company not responding to the message within a specified response time.

In some embodiments, predicting the caller's communication message prior to the caller's communication message being delivered to the user may include using the LLM trained on conversational datasets to analyze context and predict probably next words or phrases based on the caller's prior communication. Further, predicting the caller's communication message prior to the caller's communication message being delivered to the user may include dynamically adapting the prediction based on inputs including the text message produced by the ASR engine. Further, predicting the caller's communication message prior to the caller's communication message being delivered to the user may include incorporating historical data comprising historical communication messages to enhance the prediction process. Further, predicting the caller's communication message prior to the caller's communication message being delivered to the user may include generating a probability value used to determine an authenticity of the communication message.

In some embodiments, generating the probability value used to determine the authenticity of the communication message may include computing an uncertainty value based on the probability value. In some embodiments, generating the probability value used to determine the authenticity of the communication message may include dynamically adjusting the uncertainty value by incorporating real-time context based on the communication message. In some embodiments, generating the probability value used to determine the authenticity of the communication message may include determining an uncertainty classification threshold based on the uncertainty value. In some embodiments, generating the probability value used to determine the authenticity of the communication message may include configuring the uncertainty classification threshold over time using a machine learning feedback loop, wherein accuracy is refined based on confirmed vishing attempts.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for determining data misappropriation using advanced computational models for data analysis and automated processing, in accordance with an embodiment of the disclosure;

FIG. 2 an exemplary generative AI subsystem 200, in accordance with an embodiment of the invention;

FIG. 3 illustrates an example embodiment of the system configuring the information extracted from a communication message to indicate the status of the communication, in accordance with an embodiment of the disclosure; and

FIG. 4 illustrates a process flow for determining data misappropriation using advanced computational models for data analysis and automated processing, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of an application, or part of an application that serves as a foundation for a larger piece of software and drives the functionality of the software. In some embodiments, an engine may be self-contained, but externally-controllable code that encapsulates powerful logic designed to perform or execute a specific type of function. In one aspect, an engine may be underlying source code that establishes file hierarchy, input and output methods, and how a specific part of an application interacts or communicates with other software and/or hardware. The specific components of an engine may vary based on the needs of the specific application as part of the larger piece of software. In some embodiments, an engine may be configured to retrieve resources created in other applications, which may then be ported into the engine for use during specific operational aspects of the engine. An engine may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

The present disclosure introduces a real-time vishing detection and prevention system that leverages Automatic Speech Recognition (ASR), a Large Language Model (LLM), and a RoBERTa classification model to analyze and predict vishing phone calls. The system processes real-time voice communications, converts them into text, extracts key information, and predicts the caller's next words before they are spoken. By comparing extracted details with a reference database and analyzing conversation patterns, the system classifies calls as Legitimate, Probable Vishing, or Vishing and alerts the user accordingly. This integration of AI-driven speech recognition, predictive modeling, and classification provides an intelligent and automated approach to countering vishing attacks.

In today's digital landscape, vishing (wherein a malicious individual attempts to misappropriate a user's data over the phone) attacks are increasingly prevalent, where scammers impersonate trusted organizations to extract sensitive information from individuals. Traditional methods of detection rely on user reports or post-call analysis, which are reactive and often ineffective in preventing real-time financial losses and data breaches. Existing solutions do not provide a proactive mechanism to identify deceptive calls before sensitive data is compromised. Furthermore, the reliance on human judgment and manual intervention increases the likelihood of vishing attempts going undetected. The need for an automated, real-time, and adaptive system to detect and classify vishing has become increasingly necessary to enhancing security for individuals and businesses.

What is more, the present disclosure provides a technical solution to a technical problem. As described herein, the technical problem the inability of conventional systems to detect and classify vishing attacks in real time, leading to financial losses, privacy breaches, and compromised sensitive data. The technical solution presented herein allows for the automated identification of vishing calls by using AI-based models to analyze live voice communications, predict suspicious patterns, and classify calls before the vishing attack is carried out. In particular, the system as described herein is an improvement over existing solutions to vishing detection, (i) with fewer steps to achieve the solution, thus reducing the amount of computing resources, such as processing resources, storage resources, network resources, and/or the like, that are being used (e.g., prior methods require manual flagging and database reviews, whereas this solution provides automated in-call classification), (ii) providing a more accurate solution to problem, thus reducing the number of resources required to remedy any errors made due to a less accurate solution (e.g., manual reviewing processes may misclassify a legitimate call as vishing, whereas AI models provide context to the communication message and uncertainty value), (iii) removing manual input and waste from the implementation of the solution, thus improving speed and efficiency of the process and conserving computing resources (e.g., traditional security teams manually verify calls after the fact but this system prevents vishing proactively), (iv) determining an optimal amount of resources that need to be used to implement the solution, thus reducing network traffic and load on existing computing resources (e.g., by prioritizing high probability vishing calls based on contextual cues and historical data). Furthermore, the technical solution described herein uses a rigorous, computerized process to perform specific tasks and/or activities that were not previously performed. In specific implementations, the technical solution bypasses a series of steps previously implemented, thus further conserving computing resources.

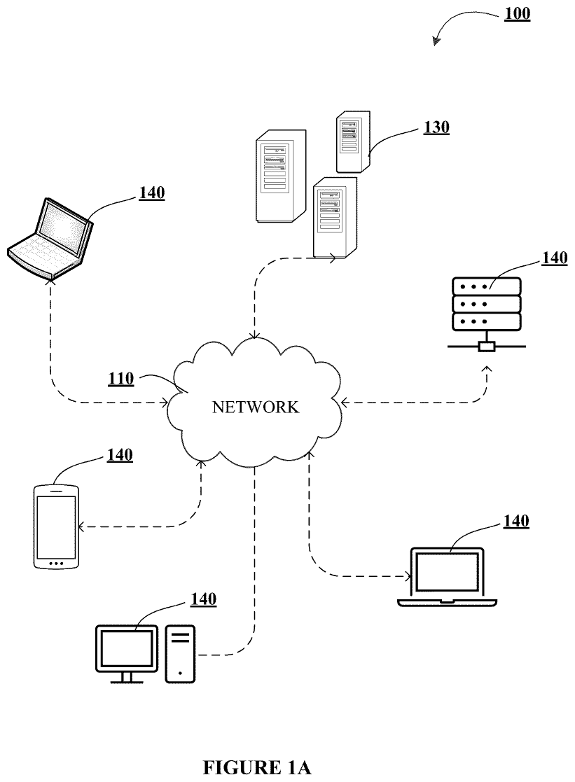

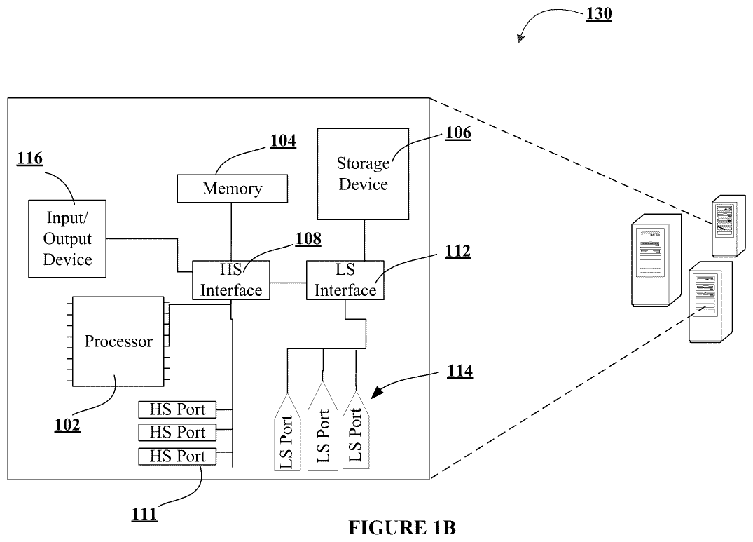

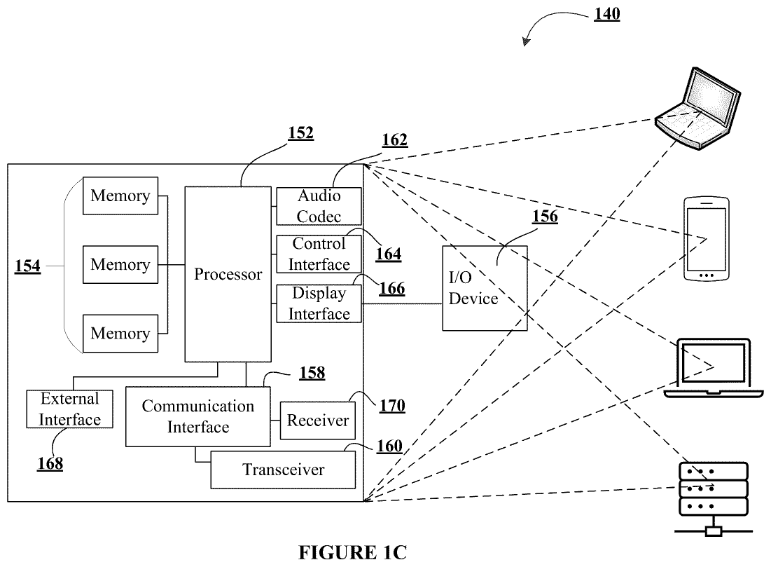

FIGS. 1A-1C illustrate technical components of an exemplary distributed computing environment 100 for determining data misappropriation using advanced computational models for data analysis and automated processing, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server (e.g., system 130). In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, resource distribution devices, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. In some embodiments, the network 110 may include a telecommunication network, local area network (LAN), a wide area network (WAN), and/or a global area network (GAN), such as the Internet. Additionally, or alternatively, the network 110 may be secure and/or unsecure and may also include wireless and/or wired and/or optical interconnection technology. The network 110 may include one or more wired and/or wireless networks. For example, the network 110 may include a cellular network (e.g., a long-term evolution (LTE) network, a code division multiple access (CDMA) network, a 3G network, a 4G network, a 5G network, another type of next generation network, and/or the like), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion, or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, storage device 106, a high-speed interface 108 connecting to memory 104, high-speed expansion points 111, and a low-speed interface 112 connecting to a low-speed bus 114, and an input/output (I/O) device 116. The system 130 may also include a high-speed interface 108 connecting to the memory 104, and a low-speed interface 112 connecting to low-speed port 114 and storage device 106. Each of the components 102, 104, 106, 108, 111, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system. The processor 102 may process instructions for execution within the system 130, including instructions stored in the memory 104 and/or on the storage device 106 to display graphical information for a GUI on an external input/output device, such as a display 116 coupled to a high-speed interface 108. In some embodiments, multiple processors, multiple buses, multiple memories, multiple types of memory, and/or the like may be used. Also, multiple systems, same or similar to system 130, may be connected, with each system providing portions of the necessary operations (e.g., as a server bank, a group of blade servers, a multi-processor system, and/or the like). In some embodiments, the system 130 may be managed by an entity, such as a business, a merchant, a financial institution, a card management institution, a software and/or hardware development company, a software and/or hardware testing company, and/or the like. The system 130 may be located at a facility associated with the entity and/or remotely from the facility associated with the entity.

The processor 102 can process instructions, such as instructions of an application that may perform the functions disclosed herein. These instructions may be stored in the memory 104 (e.g., non-transitory storage device) or on the storage device 106, for execution within the system 130 using any subsystems described herein. It is to be understood that the system 130 may use, as appropriate, multiple processors, along with multiple memories, and/or I/O devices, to execute the processes described herein.

The memory 104 may store information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation. The memory 104 may store any one or more of pieces of information and data used by the system in which it resides to implement the functions of that system. In this regard, the system may dynamically utilize the volatile memory over the non-volatile memory by storing multiple pieces of information in the volatile memory, thereby reducing the load on the system and increasing the processing speed.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer-or machine-readable storage medium, such as the memory 104, the storage device 106, or memory on processor 102.

In some embodiments, the system 130 may be configured to access, via the network 110, a number of other computing devices (not shown). In this regard, the system 130 may be configured to access one or more storage devices and/or one or more memory devices associated with each of the other computing devices. In this way, the system 130 may implement dynamic allocation and de-allocation of local memory resources among multiple computing devices in a parallel and/or distributed system. Given a group of computing devices and a collection of interconnected local memory devices, the fragmentation of memory resources is rendered irrelevant by configuring the system 130 to dynamically allocate memory based on availability of memory either locally, or in any of the other computing devices accessible via the network. In effect, the memory may appear to be allocated from a central pool of memory, even though the memory space may be distributed throughout the system. Such a method of dynamically allocating memory provides increased flexibility when the data size changes during the lifetime of an application and allows memory reuse for better utilization of the memory resources when the data sizes are large.

The high-speed interface 108 manages bandwidth-intensive operations for the system 130, while the low-speed interface 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed interface 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router (e.g., through a network adapter).

The system 130 may be implemented in a number of different forms. For example, the system 130 may be implemented as a standard server, or multiple times in a group of such servers. Additionally, the system 130 may also be implemented as part of a rack server system or a personal computer (e.g., laptop computer, desktop computer, tablet computer, mobile telephone, and/or the like). Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 156, 158, 160, 162, 164, 166, 168 and 170, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor 152 may be implemented as a chipset of chips that include separate and multiple analog and digital processors. The processor 152 may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156 (e.g., input/output device 156). The display 156 may be, for example, a Thin-Film-Transistor Liquid Crystal Display (TFT LCD) or an Organic Light Emitting Diode (OLED) display, or other appropriate display technology. An interface of the display may include appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a Single In Line Memory Module (SIMM) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner. In some embodiments, the user may use applications to execute processes described with respect to the process flows described herein. For example, one or more applications may execute the process flows described herein. In some embodiments, one or more applications stored in the system 130 and/or the user input system 140 may interact with one another and may be configured to implement any one or more portions of the various user interfaces and/or process flow described herein.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as GSM voice calls, SMS, EMS, or MMS messaging, CDMA, TDMA, PDC, WCDMA, CDMA2000, GPRS, and/or the like. Such communication may occur, for example, through transceiver 160. Additionally, or alternatively, short-range communication may occur, such as using a Bluetooth, Wi-Fi, near-field communication (NFC), and/or other such transceiver (not shown). Additionally, or alternatively, a Global Positioning System (GPS) receiver module 170 may provide additional navigation-related and/or location-related wireless data to user input system 140, which may be used as appropriate by applications running thereon, and in some embodiments, one or more applications operating on the system 130.

Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed application specific integrated circuits (ASICs), computer hardware, firmware, software, and/or combinations thereof.

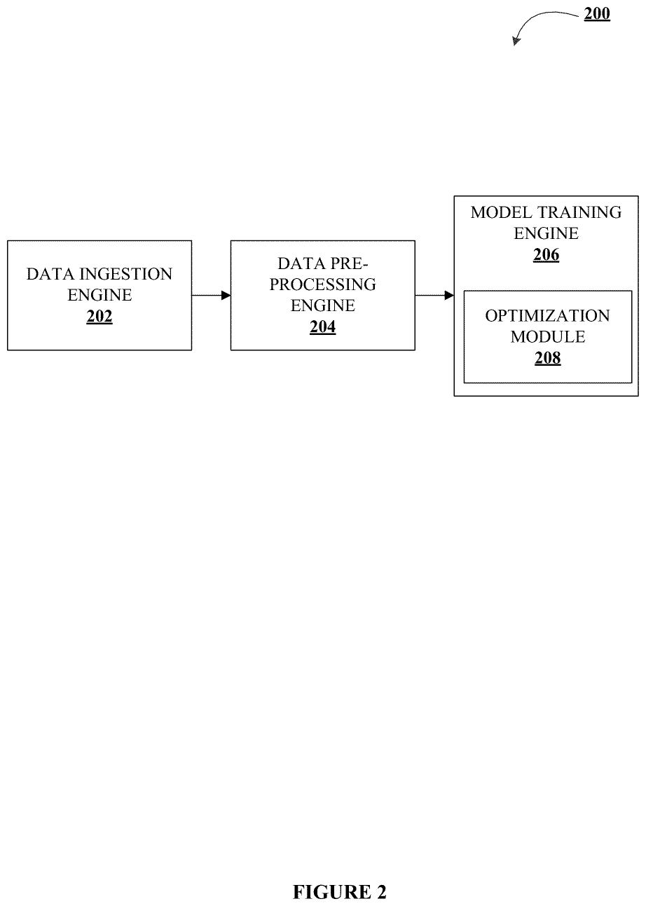

FIG. 2 illustrates an exemplary generative AI subsystem 200, in accordance with an embodiment of the invention. The generative AI subsystem 200 may include a data ingestion engine 202, a data pre-processing engine 204, and a model training engine 206. It should be understood that the generative AI subsystem 200 is merely an example, and other embodiments may include more, fewer, or different components depending on the specific requirements and implementations of the system. For instance, additional engines for data validation, feature selection, or distributed computing may be integrated into the subsystem, or certain components described herein may be consolidated or omitted based on system performance objectives. Therefore, the generative AI subsystem 200 should not be considered limiting and may be adapted to various configurations within the scope of the invention.

The data ingestion engine 202 may identify various internal and/or external data sources to generate, test, and/or integrate new features for training the generative AI model. These internal and/or external data sources (e.g., text corpora, web-based text data, document repositories, or decentralized text storage system) may be initial locations where the data originates or where physical information is first digitized. In addition to conventional data sources, the data ingestion engine 202 may support decentralized storage systems, such as blockchain-based data sources, and privacy-preserving methods such as differential privacy. The data ingestion engine 202 may identify the location of the data and describe connection characteristics for access and retrieval of data. In some embodiments, data is transported from each data source using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the data sources may include Enterprise Resource Planning (ERP) databases that host data related to day-to-day business activities such as accounting, procurement, project management, exposure management, supply chain operations, and/or the like, mainframes that are often the entity's central data processing center, edge devices that may be any piece of hardware, such as sensors, actuators, gadgets, appliances, or machines, that are programmed for certain applications and may transmit data over the internet or other networks, and/or the like.

Depending on the nature of the data, the data ingestion engine 202 may move the data to a destination for storage or further analysis. Typically, the data may be in varying formats as the data comes from different sources, including RDBMS, other types of databases, S3 buckets, CSVs, or from streams. For a large language model (“LLM”), text data may originate from sources such as web scrapes, social media, large public text datasets, or the like. Since the data may come from different places, the data needs to be cleansed and transformed so that the data may be analyzed together with data from other sources. The data may be ingested in real-time, using stream processing, in batches using a batch data warehouse, or in a combination of both. Stream processing may be used to process continuous data streams (e.g., data from edge devices) by computing on data directly as it is received, and filtering the incoming data to retain specific portions that are deemed useful by aggregating, analyzing, transforming, and/or ingesting the data. On the other hand, the batch data warehouse may collect and transfer data in batches according to scheduled intervals, triggered events, and/or any other logical ordering.

The generative AI subsystem 200 may utilize one or more machine learning techniques to generate new content. In machine learning, the quality of data and the useful information that may be derived therefrom directly affects the ability of the machine learning model to learn. The data pre-processing engine 204 may implement advanced integration and processing steps needed to prepare the data for machine learning execution, including tokenization, text normalization, and/or removal of irrelevant elements like HTML tags in web-based data, especially for LLM training. This may include modules to perform any upfront data transformation to consolidate the data into alternate forms by changing the value, structure, and/or format of the data by using generalization, normalization, attribute selection, aggregation, and text-specific transformations such as stemming and lemmatization to data clean by filling missing values, smoothing the noisy data, resolving the inconsistency, removing outliers, and/or any other encoding steps as needed. In some embodiments, the data pre-processing engine 204 may perform real-time pre-processing at the edge via edge computing devices, allowing for the transformation and reduction of data prior to transmission to centralized locations, thereby reducing latency and conserving network bandwidth.

In addition to improving the quality of the data, the data pre-processing engine 204 may transform categorical data into numerical formats that may be suitable for machine learning algorithms. In this regard, the data pre-processing engine 204 may use techniques such as one-hot encoding or label encoding depending on the nature of the categorical variables and the intended use of the data.

In some embodiments, the data pre-processing engine 204 may also include dimensionality reduction techniques, where the number of input features is reduced while retaining the most relevant information. In this regard, the data pre-processing engine 204 may include methods such as Principal Component Analysis (PCA) or apply feature selection algorithms to remove redundant or irrelevant features, thereby reducing the computational complexity of the model training phase. Feature selection may be particularly beneficial in datasets with a high number of features, ensuring that the generative AI models do not overfit to noise or irrelevant details. The pre-processed data output from the data pre-processing engine 204 may then be fed into the model training engine 206.

The model training engine 206 may be responsible for training the generative AI models using the pre-processed data from the data pre-processing engine 204. The model training engine 206 may implement various machine learning algorithms, including but not limited to Generative Adversarial Networks (GANs), Variational Autoencoders (VAEs), transformers, diffusion models, and/or other specialized architectures depending on the specific requirements of the system. These models may be used in a broad range of applications, such as LLMs for text generation, image generation models, video synthesis models, audio generation models, and/or the like. The model training engine 206 may optimize these models by continuously adjusting their internal parameters based on the patterns and relationships identified within the data.

In some embodiments, the model training engine 206 may include a training data handler, which manages the partitioning of the pre-processed data into training, validation, and testing datasets. The training data may be used to update the model's parameters, while the validation and testing datasets may be reserved to evaluate the model's performance during and after training. The model training engine 206 may support various data-handling strategies, such as cross-validation or random shuffling, to ensure that the model generalizes well and is not overfitting to the training data.

In embodiments involving large language models, the model training engine 206 may utilize transformer-based architectures, such as the Transformer, BERT, GPT, or the like. Transformer models rely on mechanisms like self-attention to capture dependencies between words in a sequence, regardless of their distance from one another. The self-attention mechanism allows the model to weigh the importance of different words in a sentence and establish complex relationships important for understanding context. During training, the model may process vast amounts of text data and learn to predict the next word or token in a sequence based on the input context. This training process allows LLMs to generate coherent text, complete sentences, translate languages, or answer questions based on learned patterns from the data.

The transformer-based LLMs may be trained using autoregressive (e.g., GPT) or masked-language modeling techniques (e.g., BERT). In autoregressive models, the training process may include predicting the next word in a sequence by progressively revealing more context to the model. The model iteratively improves its predictions based on its performance during prior iterations. Masked-language modeling involves masking certain words in a sentence and training the model to correctly predict the masked words based on surrounding context. Both approaches enable LLMs to capture intricate patterns in human language, improving their ability to handle tasks such as summarization, translation, and text generation. Loss functions like cross-entropy loss may be used to optimize the model's performance by comparing predicted tokens with the actual tokens in the dataset to guide the model to minimize prediction errors during training, as described in further detail herein.

In embodiments involving image generation models, the model training engine 206 may utilize transformer-based architectures, such as Vision Transformers (ViTs) or generative adversarial networks (GANs). Vision Transformers rely on self-attention mechanisms to process images as sequences of patches rather than whole images, allowing the model to capture spatial dependencies and patterns across the image. During training, the model may be exposed to large datasets containing diverse image types to learn features like textures, edges, and shapes. The model may then generate or reconstruct images by interpreting these patterns and applying learned spatial relationships. GAN-based models may also be used, where a generator network creates images, and a determinator network evaluates their realism, enabling the model to improve through adversarial training.

Image generation models may employ various training techniques, such as pixel-wise reconstruction or adversarial training, depending on the architecture. Pixel-wise reconstruction methods involve learning to reconstruct an image from its corrupted or downscaled version, optimizing the model to minimize the difference between the predicted and actual pixels (e.g., using mean squared error as the loss function). Adversarial training, often used with GANs, involves iteratively improving the generator network to produce images that are increasingly indistinguishable from real images, based on feedback from the determinator network. These approaches allow the model to capture complex visual features, enabling applications such as image synthesis, enhancement, and style transfer.

For video generation models, the model training engine 206 may employ transformer-based architectures like Video Transformers or GAN-based models specifically designed for handling temporal sequences. Video Transformers use self-attention mechanisms to model dependencies not only between pixels within a single frame but also across frames, allowing them to understand temporal relationships and motion patterns in videos. The model may be trained on large video datasets, enabling it to learn and reproduce dynamic changes and interactions between objects over time. GAN-based video models may incorporate spatiotemporal networks to evaluate the realism of generated video sequences, optimizing the model to produce continuous and coherent frames.

Video generation models may utilize spatial-temporal modeling techniques or adversarial training for generating realistic motion and video sequences. Spatial-temporal modeling involves learning the spatial features within each frame while simultaneously capturing the temporal dependencies between frames, optimizing the model's ability to predict future frames or complete missing sequences. Loss functions like mean squared error or perceptual loss may be applied to reduce discrepancies between predicted and actual frames. Adversarial training, on the other hand, may involve a generator creating video sequences and a determinator evaluating their realism, encouraging the generator to improve by minimizing the discrepancy identified by the determinator. These techniques may enable video generation models to create coherent and realistic sequences, useful in applications such as video synthesis and animation.

In audio generation models, the model training engine 206 may utilize architectures such as Audio Transformers or recurrent neural networks (RNNs) like WaveNet, designed to handle sequential and waveform data. Audio Transformers leverage attention mechanisms to capture relationships between segments of audio, allowing them to model temporal dependencies and predict the next audio sample based on previous context. During training, the model may process large audio datasets containing diverse sound patterns to learn representations of different audio features, such as frequency, amplitude, and harmonics. This training enables the model to generate coherent audio sequences, including speech, music, or ambient sounds, by synthesizing these learned patterns.

Audio generation models may be trained using sequence modeling techniques or autoregressive methods, depending on the architecture. Sequence modeling techniques involve processing and predicting sequences of audio samples, optimizing the model to capture and reproduce temporal dependencies in sound. Autoregressive methods, such as those employed in WaveNet, focus on predicting each audio sample based on prior samples, progressively refining the generated audio sequence over multiple iterations. Loss functions like mean absolute error or cross-entropy loss may be used to minimize the error between predicted and actual audio samples, guiding the model to improve its accuracy. These approaches allow audio generation models to create continuous and realistic audio outputs, applicable in areas such as speech synthesis, music generation, and sound effect creation.

The reconstruction loss ensures that the difference between the original input and the reconstructed output is minimized, guiding the decoder to generate outputs that closely resemble the input data. The second component, KL divergence loss, regularizes the latent space by ensuring that the distribution of latent variables conforms to a predefined probabilistic distribution, often a Gaussian distribution. This constraint encourages the model to learn a well-organized and smooth latent space, allowing for meaningful sampling from this space during inference. By combining these loss functions, the VAE can learn a latent space that not only captures the underlying patterns in the data but also allows for the generation of novel outputs by sampling new points from this space. During the inference phase, the trained model can sample random points from the latent space to generate new, previously unseen data instances.

In training generative AI models, the model training engine 206, which includes an optimization module 208, may implement various optimization techniques to improve model performance and efficiency. The optimization module 208 is responsible for adjusting the model's internal parameters continuously, using feedback from relevant loss functions tailored to the application (e.g., text, image, audio, or video generation). Techniques such as gradient clipping, learning rate scheduling, and mixed-precision training are applied by the optimization module 208 to stabilize and fine-tune the training process. Gradient clipping may be used to stabilize the training process, especially in transformer-based models, by capping the magnitude of gradients to prevent them from becoming excessively large. Learning rate scheduling may involve gradually increasing the learning rate during initial training phases (warm-up) and then decaying it as training progresses to fine-tune the model's parameters more effectively. Mixed-precision training, which leverages lower-precision (e.g., float16) arithmetic while retaining higher precision (e.g., float32) for specific calculations, may be used to accelerate training and reduce memory consumption, enabling the model to scale efficiently even when trained on large datasets.

In some embodiments, the model training engine 206 may implement early stopping mechanisms to prevent overfitting. Early stopping monitors the generative AI model's performance on the validation dataset, halting the training process if the performance does not improve after a specified number of iterations. This ensures that the generative AI model does not continue training on noise or irrelevant patterns, which could degrade its performance on unseen data. The model training engine 206 may also support distributed training across multiple computing nodes, allowing the system to scale its computational resources as needed. Distributed training may involve splitting the generative AI model and data across multiple machines or GPUs, where each node processes a portion of the data and updates the model in parallel. This is particularly useful for large datasets or models that require significant computational power, such as deep generative models. The model training engine 206 may synchronize the updates across the nodes using techniques like synchronous or asynchronous gradient descent.

Once the generative AI model is trained, the model training engine 206 may save the final trained generative AI model in a persistent storage location for future use. In specific embodiments, metadata such as the number of epochs, the final loss values, and values of learned parameters may be logged for model versioning and/or retraining at a later stage. In some embodiments, the model training engine 206 may also implement transfer learning, where a pre-trained model is fine-tuned on a smaller, domain-specific dataset. This may reduce the amount of time and data required to train a new model, especially in cases where the available data is limited or highly specialized. The model training engine 206 may adjust the parameters of the pre-trained model to better align with the new dataset, while preserving the learned features from the original training.

In embodiments involving LLMs, new output is generated by sampling from the model's probability distribution of tokens, conditioned on the context provided as input. Transformer-based architectures, such as GPT, use an auto-regressive approach where the model predicts the next token in a sequence one step at a time, using previously generated tokens as input for subsequent predictions. The process starts with a prompt or an initial sequence of words, and the model iteratively generates new tokens, forming coherent sentences or paragraphs based on the learned context and language patterns. For masked-language modeling (e.g., BERT), new output may be generated by filling in masked parts of the input sequence, allowing the model to complete sentences or generate variations of the provided text. The generated output can be controlled by adjusting parameters which influences the randomness of the token sampling, enabling the generation of diverse or deterministic responses.

In image generation models, such as those using ViTs or GANs, new output is generated by sampling from the learned distribution in the model's latent space. For GANs, the generator network creates an image by transforming random noise vectors into structured image outputs through a series of layers that learn visual features like shapes, textures, and colors. The generated image is then refined through adversarial feedback from the determinator network, which assesses the realism of the generated output. For transformer-based image models, the process may involve reconstructing images by assembling patches based on the learned dependencies between them. Input conditions, such as prompts describing desired features or specific noise vectors, guide the generation process, allowing for the creation of customized images or variations of existing visual styles. These models may also generate images based on style transfer techniques or predefined templates, synthesizing images that align with the characteristics present in the training data.

Video generation models utilize spatiotemporal dependencies to synthesize new video sequences based on the patterns learned during training. In transformer-based architectures, the model may generate video frames sequentially, predicting the next frame based on the input frames and the temporal context established by prior frames. GAN-based models, specifically designed for video synthesis, may sample noise vectors or use a sequence of frames as input, transforming these into continuous and temporally coherent video outputs through the generator network. The determinator evaluates the temporal consistency and realism of the output, ensuring the generated video mimics the motion dynamics and object interactions present in real-world video data. Such models may also use attention mechanisms to focus on critical elements within each frame and their evolution across time, facilitating realistic scene transitions and motion patterns. The generation process may include user-defined input such as initial frames, motion descriptions, or specific video attributes, providing control over the output.

Audio generation models, including Audio Transformers or autoregressive architectures like WaveNet, generate new audio sequences by predicting audio samples based on learned dependencies in sequential sound data. For autoregressive models, the generation process involves producing each audio sample one at a time, conditioned on previously generated samples, allowing the model to build complex audio patterns such as speech, music, or ambient sounds. The model starts with an initial segment or a random seed and uses its learned parameters to predict and synthesize subsequent samples, constructing a continuous audio waveform. Audio Transformers, on the other hand, may use attention mechanisms to identify important temporal segments within the input audio and synthesize new output based on these learned patterns. The user can control the type of audio generated by providing parameters such as pitch, tempo, or initial sound clips, enabling the model to generate outputs tailored to specific use cases like speech synthesis, music composition, or environmental sound generation.

In some embodiments, generative AI models may also integrate multiple modalities, enabling cross-modal generation where output in one modality influences or conditions the generation in another. For example, a video generation model may use text descriptions as input, synthesizing video content that aligns with the specified narrative or visual scene described. Similarly, image generation models may generate visual representations based on audio inputs, such as generating animations synchronized to musical rhythms or speech patterns. These cross-modal systems typically involve conditional GANs or multi-modal transformers, where the model processes input from one domain (e.g., text or audio) and learns to generate output in another domain (e.g., video or image) by aligning the patterns and dependencies between the different modalities. These models may allow users to generate complex, multimodal content based on combinations of inputs, such as using textual prompts to control the visual and auditory elements of a video.

It will be understood that the embodiment of the generative AI subsystem 200 illustrated in FIG. 2 is exemplary and that other embodiments may vary. The generative AI subsystem 200, as well as its constituent elements, may vary, and modifications or alternative configurations may be implemented without departing from the broader scope of the invention. For instance, different machine learning algorithms, data sources, optimization techniques, or training methodologies may be employed depending on system requirements, application domain, and available computational resources. Furthermore, features and functionalities described in one embodiment may be combined with those of another embodiment as needed, and vice versa.

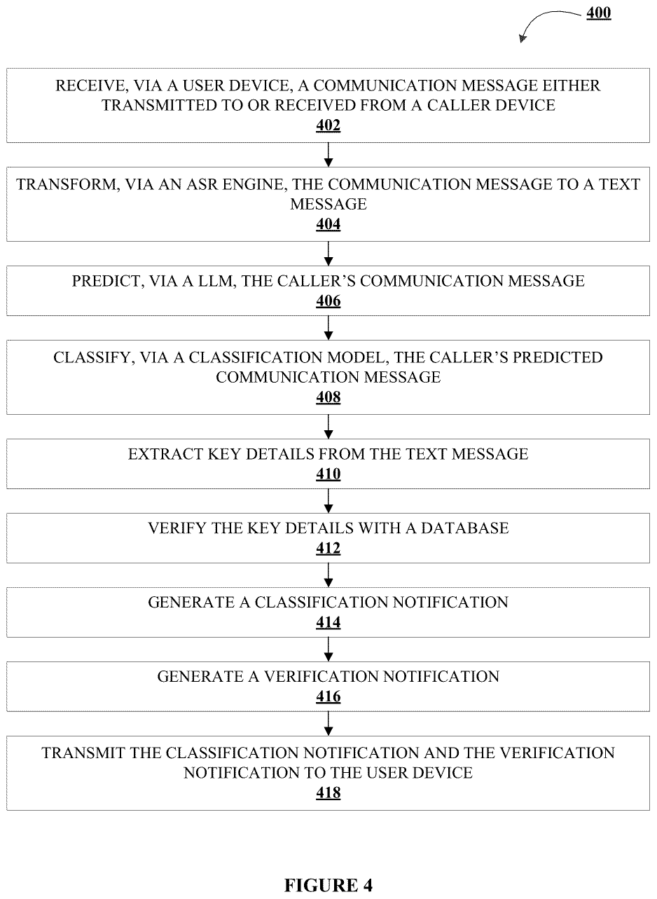

FIG. 4 illustrates a process flow for determining data misappropriation using advanced computational models for data analysis and automated processing, in accordance with an embodiment of the disclosure. The method may be carried out by various components of the distributed computing environment 100 discussed herein (e.g., the system 130, one or more end-point device(s) 140, etc.). An example system may include at least one processing device and at least one non-transitory storage device with computer-readable program code stored thereon and accessible by the at least one processing device, wherein the computer-readable code when executed is configured to carry out the method discussed herein.

In some embodiments, a system (e.g., similar to one or more of the systems described herein with respect to FIGS. 1A-1C) may perform one or more of the steps of process flow 400. For example, a system (e.g., the system 130 described herein with respect to FIGS. 1A-1C) may perform the steps of process flow 400.

As shown in block 402, the process flow 400 of this embodiment includes receiving, via a user device, a communication message either transmitted to or received from a caller device. For example, in some embodiments, the system may receive, via a user device associated with a user, a communication message including either an incoming communication message or an outgoing communication message, wherein the communication message is either transmitted to or received from a caller device, and wherein the communication message includes real-time voice communication between the user and a caller.

In the context of the present disclosure, a “communication message” may refer to any data transmission that facilitates the exchange of information between two or more devices. For example, this may include, but is not limited to, voice calls, text messages, multimedia messages, Voice over Internet Protocol (VoIP) communications, and/or data packets exchanged over telecommunication networks. Further, a communication message may be incoming or outgoing and may occur over various channels including but not limited to cellular networks, the internet, private networks, or the like.

As used herein, a “phone call” or “call” may include a specific type of communication message characterized by the real-time exchange of audio signals between a caller device and a receiver device (e.g., user device). In some embodiments, the phone call may be described as a bi-directional voice communication session established over a telecommunication network. Further, the communication message (e.g., communication session) may occur through various technologies, including but not limited to Public Switched Telephone Network (PSTN), Voice over Internet Protocol (VoIP), Cellular Networks (e.g., 3G, 4G, 5G, or the like).

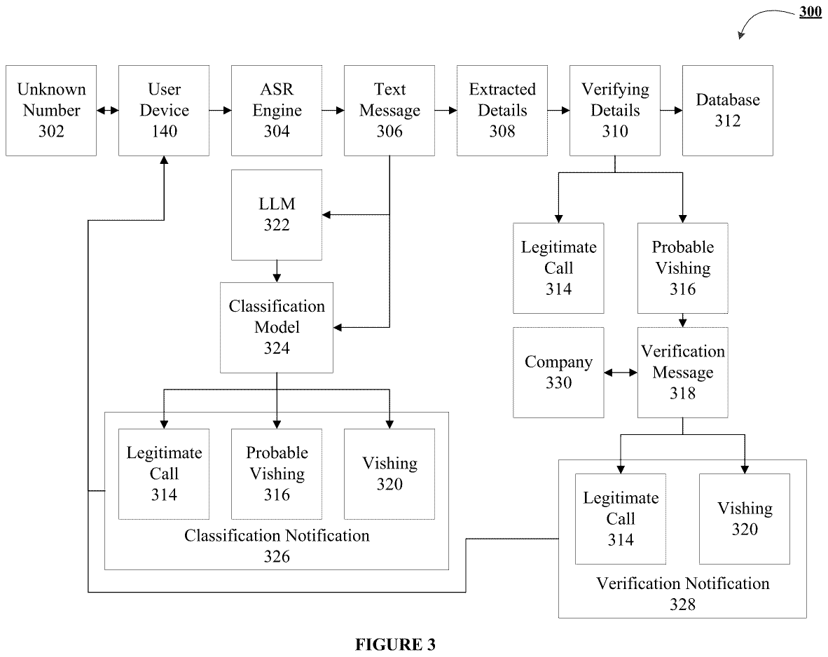

In some embodiments, the caller device address may be unrecognized by or unknown to the user device. For example, as shown in block 302 of FIG. 3, the user device 140 may receive a communication message, call, or the like from an unknown number 302. In this way, the caller device address may include a phone number that the user device does not recognize. For example, an unrecognized or unknown number 302 may include a caller device address such as a phone number, VoIP address, Session Initiation Protocol (SIP) identifier that the user device does not recognize from its stored contact list or call history. Further, in some embodiments, the user device may be connected to a network with its own database of contact information from caller devices. For example, if the user device is associated with a company with a database of contact information and the caller's information is not stored within the database, the system may be activated. In this regard, if the network's database does not recognize the caller number, the system may be activated.

In some embodiments, an unknown number calling the user device may trigger the system. Further, in some embodiments, the user using the user device to place a call to an unknown number may trigger the system to activate. In this way, the system and solutions as described herein may, in some embodiments, be triggered or otherwise activated when the user device is attempting to communicate with an unknown number of a caller. Further, in some embodiments, the system may automatically initiate processes such as capturing metadata related to the call (e.g., key details such as caller ID, time, duration, and the like), activating the ASR engine to prepare for voice-to-text conversion, and the like.

Further, in some embodiments, the activation of the solutions provided herein may begin when a call to the unknown or unrecognized number is either placed or received during the connection phase of the call. In this regard, the system may be initialized prior to the call between the user device and the caller device being connected. Further, in other embodiments, the system may be triggered or initialized after the call has been connected. In other words, in some embodiments, the system may initialize after the communication message (e.g., call) has been connected between the user device and the caller device.

As shown in block 404, the process flow 400 of this embodiment may include transforming, via an Automatic Speech Recognition (ASR) engine, the communication message to a text message. The ASR engine may be responsible for converting real-time voice communication data (e.g., including spoken language between the user and the caller) into a structured text format (e.g., the text message). The structured text message may be used downstream for processes such as natural language processing (NLP), machine learning based classification, and real-time vishing determinations. For example, as shown in FIG. 3, the ASR engine 304 may receive the communication message (e.g., the data associated with the call) from the user device 140 and convert it to a text message 306. Further, the ASR engine may preprocess the audio data to enhance speech clarity for accurate recognition techniques, segment the audio data to identify words or phrases, and decode the phonetic data via language models trained on diverse conversational datasets. In some embodiments, the ASR transformation may occur in real time with minimal latency to avoid disruptions to the user experience.

As shown in block 406, the process flow 400 of this embodiment may include predicting, via a LLM, the caller's communication message. In some embodiments, the system may predict, via an LLM, the caller's communication message prior to the caller's communication message being delivered to the user. For example, as shown in block 322 of FIG. 3, the LLM 322 may receive the text message 306 created by the ASR engine 304 to use an input for predicting what the caller's next communication may be. In this regard, the LLM 322 may be designed to anticipate the probable next words, phrases, or sentences from the caller based on the current context of the conversation (e.g., the communication message). In some embodiments, the predictive capability of the LLM may allow the system to proactively assess potential security issues prior to the caller's message being delivered to the user. For example, the LLM may assess the caller's communication and predict the caller's next communication before the caller actually makes that next communication. In other words, the LLM may make a prediction about the caller's next words or phrases prior to the caller actually speaking those words or phrases.

In some embodiments, predicting the caller's communication prior to the caller's communication message being delivered to the user may include using the LLM trained on conversational datasets to analyze context and predict probable next words or phrases based on the caller's prior communication. In some embodiments, the training datasets used for the LLM may include a wide variety of communication scenarios, encompassing both legitimate interactions and/or known vishing attempts. The training datasets enable the model to recognize subtle linguistic cues, conversational patterns, and semantic structures that may indicate potential vishing attempts.

In some embodiments, predicting the caller's communication may include dynamically adapting the predication based on inputs including the text message produced by the ASR engine. In this regard, the prediction of the caller's communication may be a dynamic and adaptive process that continuously evolves based on real-time inputs (e.g., the text message 306). Further, in some embodiments, the dynamic adaptation may allow the system to proactively assess potential vishing attempts prior to the caller completing their statement, enabling real-time intervention techniques.

In some embodiments, predicting the caller's communication may include incorporating historical data including historical communication messages to enhance the prediction process. The historical data may provide context to enhance the LLM's 322 ability to predict vishing attempts. For example, if a specific phone number has been flagged previously for vishing attempts, the LLM may factor that into the decision making process. Further, the LLM may create behavioral patterns based on past interactions enabling it to identify anomalies that deviate from typical communication patterns.

In some embodiments, predicting the caller's communication message may include generating a probability value used to determine an authenticity of the communication message. In some embodiments, the probability value may be used to reflect the system's confidence in whether the caller's communication aligns with patterns of legitimate interactions or exhibits characteristics commonly associated with vishing. In some embodiments, generating the probability value may include computing an uncertainty value based on the probability value. The uncertainty value may quantify the system's level of confidence in the classification decision. For example, a low uncertainty indicates high confidence in the prediction while a high uncertainty value indicates ambiguity with the decision.

In some embodiments, generating the probability value may include dynamically adjusting the uncertainty value by incorporating real-time context based on the communication message. In this regard, the incorporation of real-time contextual data may be used to dynamically adjust the uncertainty value. For example, the real time data may include new information extracted from the caller's communication as the conversation progresses, changes in tone, language, or behavior, and/or verification feedback from external sources such as the company 330. In some embodiments, generating the probability value may include determining an uncertainty classification threshold based on the uncertainty value. In some embodiments, the threshold may serve as a decision boundary that influences how the communication message will be classified. In some embodiments, generating the probability value may include configuring the uncertainty classification threshold over time using a machine learning feedback loop, wherein accuracy is refined based on confirmed vishing attempts. In some embodiments, the feedback loop may enable the system to learn from real-world outcomes, such as confirmed vishing attempts, false positives, false negatives, and the like. The data may be used to refine the model's parameters continuously.

As shown in block 408, the process flow 400 of this embodiment may include classifying, via a classification model, the caller's predicted communication message. In some embodiments, the classification model (e.g., the classification model 324 as shown in FIG. 3) may use inputs such as the text message 306 and the output from the LLM 322 to determine a status of the communication message. The status of the communication message may be either authentic, probable vishing, or vishing. In some embodiments, a communication message designated as an authentic communication message may be a legitimate call (e.g., the legitimate call 314) from a caller attempting to conduct legitimate business. In some embodiments, a communication message designated as probable vishing (e.g., probable vishing 316) may include a communication message that has tendencies towards a vishing message but has not yet been confirmed to be a vishing attempt. In some embodiments, a communication message designated as vishing (e.g., vishing 320) may include a message that has been confirmed to include a vishing attempt by the caller.

In some embodiments, the classification model (e.g., the classification model 324) may be implemented using advanced machine learning algorithms, such as a Robustly Optimized BERT Pretraining Approach (RoBERTa) classifier. In some embodiments, the classification model 324 may evaluate multiple input features, including but not limited to the predicted communication message generated by the LLM, the text message produced by the ASR engine, contextual metadata (e.g., caller ID, call duration, historical interactions), probability values and uncertainty scores associated with the LLM predictions, and the like.

As shown in block 410, the process flow 400 of this embodiment may include extracting key details from the text message. For example, in some embodiments, the system may extract one or more key details (e.g., the extracted details 308) from the text message, wherein the key details include the caller's name, the company associated with the caller, and the caller device's address. In some embodiments, the caller device's address may include a phone number.

In some embodiments, the system 130 may use NLP processing techniques to analyze the text message (e.g., the text message 306) to identify and extract the key details used for determining the authenticity of the caller. The extraction process may scan the text message 306 for predefined patterns, keywords, and contextual markers that may indicate the presence of important information. In some embodiments, the system may use entity recognition algorithms, semantic analysis models, or the like to help differentiate between generic content and identifiable details used for classifying the communication message and/or verifying the caller. For example, if a message includes multiple names or organizations, the system may determine which entity is directly linked to the caller based on linguistic cues and positional context within the sentence.

As shown in block 412, the process flow 400 of this embodiment may include verifying the key details with a database. In some embodiments, the system may verify the one or more key details via comparing the one or more key details with a database. In some embodiments, the database (e.g., the database 312) may be a public databased that stores public records associated with the company or organization the caller purports to be associated with. Further, in some embodiments, the database 312 may be a private database that is used for verification purposes by the system. The private database may contain a wide range of verified records, including authorized personnel lists, company directories, previously authenticated phone numbers, or the like, which may serve to verify the incoming communication.

In some embodiments, verifying the one or more key details may include querying the database 312 using the one or more key details (e.g., the extracted details 308). In some embodiments, the system may perform real-time queries during ongoing phone calls between the user and the caller. In some embodiments, the query may be structured to retrieve exact matches or probable matches from the database, wherein the probable matches may account for slight variations such as misspellings, formatting inconsistencies, abbreviations, or the like. Further, in some embodiments, the system may retrieve a legitimate match from the database. In some embodiments, the legitimate match may indicate the caller's information (e.g., the caller name, company affiliation, device address or number) aligns with the records associated with the database, confirming the communication message is authentic and not a vishing attempt.

Further, in some embodiments, and as discussed in greater detail below, the system may configure the verification notification (e.g., the verification notification 328) to indicate the legitimate match, which may be based on the legitimate call 314. In this regard, the verification notification 328 may be automatically generated and presented via a graphical user interface (e.g., the screen) of the user device 140. In some embodiments, the verification notification 328 may include information such as the verification status, the matched details, the confidence score which indicates the confidence in the matched details.

Further, in other embodiments, verifying the one or more key details may include querying the database using the one or more key details and receiving a mismatch from the database. In some embodiments, the mismatch may occur when the queried information does not correspond with any record in the database or when inconsistencies are identified between the extracted details 308 and the data associated with the database 312. The mismatch may indicate the caller's identity, contact information, or organizational affiliation is unauthorized, fabricated, or otherwise non-authentic thereby raising a flag for probable vishing activity (e.g., probable vishing 316). For example, the mismatch may include but is not limited to an absence of a corresponding record in the database, partial mismatches where certain details are valid but other details do not align with the records, and inconsistencies in data formats (e.g., discrepancies between the caller's claimed location and associated area code or international dialing code). In some embodiments, the system may configure the verification message 318 to indicate the mismatch and to indicate the communication message is probable vishing 316. In some embodiments, the verification notification may include a mismatch status indicator, an assessment level (e.g., “probable vishing”), details of the mismatched data, and recommended actions. In some embodiments, the recommended actions may include warnings to the user to not share sensitive information, terminate the call, or the like.

In some embodiments, verifying the key details may include transmitting a verification message to the company associated with the caller, wherein the verification message requests confirmation that the caller is associated with the company. In this regard, the system may transmit the verification message 318 to the company 330 the caller purports to be associated with. In some embodiments, the verification message 318 may be an automated inquiry requesting confirmation regarding the authenticity of the caller's identity and their association with the specified organization or company 330. In some embodiments, the verification message 318 may be transmitted via secure channels such as encrypted email, API requests, or other secure messaging protocols. In some embodiments, the verification message 318 may include the extracted key details from the call (e.g., the caller's name, claimed position or department within the company, phone number, or other identifying information), a specific inquiry to confirm the individual is legitimately associated with the company 330, and any other metadata associated with the call (e.g., timestamps, call duration, caller device address, or the like). Further, this may include configuring the verification notification 328 to indicate the communication message is either a legitimate call 314 or vishing 320. In some embodiments, designating the communication message as authentic (e.g., a legitimate call 314) may include receiving confirmation from the company 330 that the caller is associated with the company 330.

In some embodiments, designating the communication message as vishing 320 may include receiving information from the company 330 that the caller is not associated with the company 330. In some embodiments, the company 330 may respond with a negative confirmation and explicitly state the caller in question is not an employee, representative, or otherwise associated with the company 330. For example, if the company 330 confirms that no such caller is affiliated with them, the system may immediately flag the call as vishing 320. Further, the system may also log the response for audit purposes and future detection pattern analysis.

Further, in some embodiments, designating the communication message as vishing 320 may be in response to the company 330 not responding to the message within a specified response time. In this regard, the communication may be designated as vishing 320 in the absence of a direct response from the company 330, specifically when the company 330 fails to respond to the verification message 318 within a specified response time. The specified response time may ensure that potential security issues are not left unresolved due to delays in third-party (e.g., the company's 330) verification. Further, in some embodiments, the specified response time may be dynamically configured based on factors such as uncertainty level of the call, the sensitivity of the information communicated during the call, the sensitivity of the information requested in the verification message 318, and historical response times of the company 330, if any. For example, a verification message 318 related to a caller claiming to represent a financial institution may have a shorter response window (e.g., specified response time) due to the sensitivity level of the information discussed during the call.

As shown in block 414, the process flow 400 of this embodiment may include generating a classification notification. In some embodiments, the system may generate a classification notification 326 including the details of the caller's predicted communication message, wherein the classification notification configures a graphical user interface of the user device 140. In some embodiments, the classification notification 326 may communicate the results of the vishing detection process, performed by the LLM 322 and the classification model 324, to the user in real time. The classification notification 326 may provide actionable insights to the system's analysis of the caller's communication, enabling the user to make informed decisions about whether to continue the call, terminate the call, or take additional security precautions.

Further, in some embodiments, the classification notification 326 may configure the GUI of the user device 140 to ensure the notification is displayed in a user-friendly manner and also to minimize disruptions to the ongoing call while conveying the necessary information. In some embodiments, the classification notification 326 may include various interface elements such as pop-up alerts or banners, color-coded security indicators, and/or interactive options that allow the user to take actions such as terminating the call, reporting the caller, or requesting additional verification. In some embodiments, the system may escalate the classification notification's 326 prominence via visual cues, audio alerts, haptic feedback, audio playback on the call, or the like.

As shown in block 416, the process flow 400 of this embodiment may include generating a verification notification. In some embodiments, the system may generate a verification notification 328 including a verification status of the one or more key details (e.g., the extracted details 308), wherein the verification notification configures the graphical user interface of the user device. In some embodiments, the verification notification 328 may display information to the user informing the user about the verification status of the key details 308 extracted from the communication message. In some embodiments, the verification notification 328 may be generated after the system has analyzed the key details 308 by comparing them to the database 312 and, when applicable, a response to the verification message 318 from the company 330 the caller purports to be associated with is received.

In some embodiments, the verification notification 328 may include verification status of the one or more key details 308. For example, the notification may indicate the verification status, such as verified (e.g., legitimate or authentic) and vishing. The verified status may indicate a legitimate call 314 wherein the caller's details have successfully matched with records in the database 312. The vishing 320 status may indicate the system has received confirmation from the company 330 that the caller is not associated with them.

As shown in block 418, the process flow 400 of this embodiment may include transmitting the classification notification and the verification notification to the user device. In some embodiments, the transmittal of the notifications (e.g., the classification notification 326 and the verification notification 328) may include real time transmittal as soon as the caller has been verified (or not) and/or classified. In some embodiments, secure transmission protocols, such as encrypted communication protocols, may be used to transmit the notifications. Further, in some embodiments, the notifications may be delivered instantaneously or near-instantaneously allowing the user device 140 for the user to receive the information without delay.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for determining data misappropriation using advanced computational models for data analysis and automated processing, the system comprising:
a processing device;
a non-transitory storage device containing instructions when executed by the processing device, causes the processing device to perform the steps of:
receive, via a user device associated with a user, a communication message comprising either an incoming communication message or an outgoing communication message, wherein the communication message is either transmitted to or received from a caller device, and wherein the communication message comprises real-time voice communication between the user and a caller;
transform, via an Automatic Speech Recognition (ASR) engine, the communication message to a text message;
predict, via a Large Language Model (LLM), the caller's communication message prior to the caller's communication message being delivered to the user;
classify, via a classification model, the caller's predicted communication message;
extract one or more key details from the text message, wherein the key details comprise the caller's name, the company associated with the caller, and the caller device's address;
verify the one or more key details via comparing the one or more key details with a database;
generate a classification notification comprising the classification of the caller's predicted communication message, wherein the classification notification configures a graphical user interface of the user device;
generate a verification notification comprising a verification status of the one or more key details, wherein the verification notification configures the graphical user interface of the user device; and
transmit the classification notification and the verification notification to the user device.

2. The system of claim 1, wherein the caller device address is unrecognized by or unknown to the user device.

3. The system of claim 1, wherein verifying the one or more key details comprises:
querying the database using the one or more key details;
retrieving a legitimate match from the database; and
configuring the verification notification to indicate the legitimate match.

4. The system of claim 1, wherein verifying the one or more key details comprises:
querying the database using the one or more key details;
receiving a mismatch from the database; and
configuring the verification notification to indicate the mismatch and to indicate the communication message is probable vishing.

5. The system of claim 4, wherein verifying the one or more key details further comprises:
transmitting a verification message to the company associated with the caller, wherein the verification message requests confirmation that the caller is associated with the company; and
configuring the verification notification to indicate the communication message is either:
authentic, upon receiving confirmation from the company that the caller is associated with the company;
vishing, upon receiving information from the company that the caller is not associated with the company; or
vishing, upon the company not responding to the message within a specified response time.

6. The system of claim 1, wherein predicting the caller's communication message prior to the caller's communication message being delivered to the user further comprises:
using the LLM trained on conversational datasets to analyze context and predict probable next words or phrases based on the caller's prior communication;
dynamically adapting the prediction based on inputs comprising the text message produced by the ASR engine;
incorporating historical data comprising historical communication messages to enhance the prediction process; and
generating a probability value used to determine an authenticity of the communication message.

7. The system of claim 6, wherein generating the probability value used to determine the authenticity of the communication message further comprises:
computing an uncertainty value based on the probability value;
dynamically adjusting the uncertainty value by incorporating real-time context based on the communication message;
determining an uncertainty classification threshold based on the uncertainty value; and
configuring the uncertainty classification threshold over time using a machine learning feedback loop, wherein accuracy is refined based on confirmed vishing attempts.

8. A computer program product for determining data misappropriation using advanced computational models for data analysis and automated processing, the computer program product comprising a non-transitory computer-readable medium comprising code causing an apparatus to:
receive, via a user device associated with a user, a communication message comprising either an incoming communication message or an outgoing communication message, wherein the communication message is either transmitted to or received from a caller device, and wherein the communication message comprises real-time voice communication between the user and a caller;
transform, via an ASR engine, the communication message to a text message;
predict, via a LLM, the caller's communication message prior to the caller's communication message being delivered to the user;
classify, via a classification model, the caller's predicted communication message;
extract one or more key details from the text message, wherein the key details comprise the caller's name, the company associated with the caller, and the caller device's address;
verify the one or more key details via comparing the one or more key details with a database;
generate a classification notification comprising the classification of the caller's predicted communication message, wherein the classification notification configures a graphical user interface of the user device;
generate a verification notification comprising a verification status of the one or more key details, wherein the verification notification configures the graphical user interface of the user device; and
transmit the classification notification and the verification notification to the user device.

9. The computer program product of claim 8, wherein the caller device address is unrecognized by or unknown to the user device.

10. The computer program product of claim 8, wherein verifying the one or more key details comprise:
querying the database using the one or more key details;
retrieving a legitimate match from the database; and
configuring the verification notification to indicate the legitimate match.

11. The computer program product of claim 8, wherein verifying the one or more key details comprises:
querying the database using the one or more key details;
receiving a mismatch from the database;
configuring the verification notification to indicate the mismatch and to indicate the communication message is probable vishing.

12. The computer program product of claim 11, wherein verifying the one or more key details further comprises:
transmitting a verification message to the company associated with the caller, wherein the verification message requests confirmation that the caller is associated with the company; and
configuring the verification notification to indicate the communication message is either:
authentic, upon receiving confirmation from the company that the caller is associated with the company;
vishing, upon receiving information from the company that the caller is not associated with the company;
vishing, upon the company not responding to the message within a specified response time.

13. The computer program product of claim 8, wherein predicting the caller's communication message prior to the caller's communication message being delivered to the user further comprises:
using the LLM trained on conversational datasets to analyze context and predict probable next words or phrases based on the caller's prior communication;
dynamically adapting the prediction based on inputs comprising the text message produced by the ASR engine;
incorporating historical data comprising historical communication messages to enhance the prediction process; and
generating a probability value used to determine an authenticity of the communication message.

14. The computer program product of claim 13, wherein generating the probability value used to determine the authenticity of the communication message further comprises:
computing an uncertainty value based on the probability value;
dynamically adjusting the uncertainty value by incorporating real-time context based on the communication message;
determining an uncertainty classification threshold based on the uncertainty value; and
configuring the uncertainty classification threshold over time using a machine learning feedback loop, wherein accuracy is refined based on confirmed vishing attempts.

15. A method for determining data misappropriation using advanced computational models for data analysis and automated processing, the method comprising:
receiving, via a user device associated with a user, a communication message comprising either an incoming communication message or an outgoing communication message, wherein the communication message is either transmitted to or received from a caller device, and wherein the communication message comprises real-time voice communication between the user and a caller;
transforming, via an Automatic Speech Recognition (ASR) engine, the communication message to a text message;
predicting, via a Large Language Model (LLM), the caller's communication message prior to the caller's communication message being delivered to the user;
classifying, via a classification model, the caller's predicted communication message;
extracting one or more key details from the text message, wherein the key details comprise the caller's name, the company associated with the caller, and the caller device's address;
verifying the one or more key details via comparing the one or more key details with a database;
generating a classification notification comprising the classification of the caller's predicted communication message, wherein the classification notification configures a graphical user interface of the user device;
generating a verification notification comprising a verification status of the one or more key details, wherein the verification notification configures the graphical user interface of the user device; and
transmitting the classification notification and the verification notification to the user device.

16. The method of claim 15, wherein the caller device address is unrecognized by or unknown to the user device.

17. The method of claim 15, wherein verifying the one or more key details comprises:
querying the database using the one or more key details;
retrieving a legitimate match from the database; and
configuring the verification notification to indicate the legitimate match.

18. The method of claim 15, wherein verifying the one or more key details comprises:
querying the database using the one or more key details;
receiving a mismatch from the database; and
configuring the verification notification to indicate the mismatch and to indicate the communication message is probable vishing.

19. The method of claim 18, wherein verifying the one or more key details further comprises:
transmitting a verification message to the company associated with the caller, wherein the verification message requests confirmation that the caller is associated with the company; and
configuring the verification notification to indicate the communication message is either:
authentic, upon receiving confirmation from the company that the caller is associated with the company;
vishing, upon receiving information from the company that the caller is not associated with the company; or
vishing, upon the company not responding to the message within a specified response time.

20. The method of claim 15, wherein predicting the caller's communication message prior to the caller's communication message being delivered to the user further comprises:
using the LLM trained on conversational datasets to analyze context and predict probable next words or phrases based on the caller's prior communication;
dynamically adapting the prediction based on inputs comprising the text message produced by the ASR engine;
incorporating historical data comprising historical communication messages to enhance the prediction process; and
generating a probability value used to determine an authenticity of the communication message.
